(19) United States
(12) Patent Application Publication
(10) Pub. No.: US 2016/0365633 A1
(43) Pub. Date: Dec. 15, 2016

(54) ANTENNA APPARATUS HAVING ABSORPTIVE SWITCH AND METHOD FOR CONTROLLING REACTANCE LOAD

(71) Applicant: Electronics and Telecommunications Research Institute, Daejeon (KR)

(72) Inventors: Young Kyun CHO, Daejeon (KR); Bong Hyuk PARK, Daejeon (KR); Jung Hoon OH, Daejeon (KR)

(21) Appl. No.: 15/061,282

(22) Filed: Mar. 4, 2016

(30) Foreign Application Priority Data
Jun. 15, 2015 (KR) 10-2015-0084176

(51) Int. Cl. H01Q 3/44

(52) U.S. Cl. CPC H01Q 3/44

(57) ABSTRACT

Provided is an antenna apparatus. The antenna apparatus includes: an active antenna configured to transmit and receive a signal; a plurality of passive antennas which are provided in a periphery of the active antenna and which determine a beam pattern; a plurality of reactance loads configured to control a driving of the plurality of passive antennas respectively; and a plurality of switching elements configured to control a driving of the plurality of reactance loads, wherein a reactance value of the plurality of reactance loads is determined according to an impedance of the plurality of switching elements and a transmission line.

### CROSS-REFERENCE TO RELATED APPLICATION

This application claims the benefit of priority to Korean Patent Application No. 10-2015-0084176, filed on Jun. 15, 2015 in the Korean Intellectual Property Office, the disclosure of which is incorporated herein in its entirety by reference.

### BACKGROUND OF THE INVENTION

Field of the Invention

The present disclosure relates to an antenna apparatus having an absorptive switch and a method for controlling a reactance load thereof, and more particularly, to a technology for efficiently controlling a reactance load of an antenna apparatus.

Description of the Related Art

Since a multiple-input multiple-output (MIMO) communication provides a maximum diversity for improving transmission reliability and can obtain a multiplexing gain characteristic for supporting a high transmission speed, it has been recognized as a promising technology. However, in a typical MIMO system, a large number of transceivers and relevant multiple antennas should be used, accordingly, the complexity in a RF domain and the increase of a hardware cost cannot be avoided. In order to overcome such a problem, a beam space MIMO antenna using a single active antenna and a plurality of parasitic antenna is suggested.

The beam space MIMO antenna is an antenna capable of emitting two information flows simultaneously with the same throughput as two antennas in the MIMO system emit and emitting two independent signals.

This beam space MIMO antenna supplies a signal to an active antenna by using a single RF chain and adjusting a current of a parasitic antenna by a signal excited through the supplied signal, so that the direction and the shape of a beam can be controlled to achieve a spatial multiplexing.

Thus, the beam space MIMO antenna may implement a MIMO system by a single RF chain and a single antenna, and implement by a low cost, a small size, and a low power consumption.

The shape and the direction of the beam for multiplexing a signal in the beam space MIMO antenna is controlled through a load of the parasitic antenna. That is, when a specific value of reactance is switched in the load of the parasitic antenna, the direction and the shape of the antenna beam is able to be changed according to the value. A load adjustment unit which enables the above operation performs a very important role of determining a spectrum of a transmission signal and a restoring characteristic in the beam space MIMO antenna. In a conventional beam space MIMO antenna, such a reactance load switching is implemented through a PIN diode or a varactor diode. These diodes have been widely used for an antenna which requires a wide range of reactance value, as they can obtain various reactance values that continuously change according to a voltage value applied to both ends of the diode.

However, the method of controlling a load reactance through the diode has some critical disadvantages.

First, since the range of a voltage that should be controlled to control the reactance value is large (approximately 9V or more), an additional voltage driving circuit is required, and it is impossible to be directly connected with a baseband digital processor.

Second, it is impossible to avoid the influence of time mismatch between multiple signals to be transmitted due to a delay time of the voltage driving circuit.

Third, additional inductor and capacitor connected in series or in parallel are required in order to obtain a reactance value of a desired area.

Fourth, since conventional diodes cannot be directly connected to the antenna to adjust the load value, an additional correction kit is required.

Fifth, since the voltage driving circuit and the diode use a high voltage and a current, it is difficult to maximize a power consumption reduction effect that can be obtained by reducing a RF chain.

### SUMMARY OF THE INVENTION

The present disclosure has been made in view of the above problems, and provides an antenna apparatus for effectively controlling a reactance load value of a beam space MIMO antenna by using an absorptive switch, and a method for controlling a reactance load thereof.

In accordance with an aspect of the present disclosure, an antenna apparatus includes: an active antenna configured to transmit and receive a signal; a plurality of passive antennas which are provided in a periphery of the active antenna and which determine a beam pattern; a plurality of reactance loads configured to control a driving of the plurality of passive antennas respectively; and a plurality of switching elements configured to control a driving of the plurality of reactance loads, wherein a reactance value of the plurality of reactance loads is determined according to an impedance of the plurality of switching elements and a transmission line. The plurality of switching elements are an absorptive switch. When the plurality of switching elements are turned off, the antenna apparatus is driven as an omnidirectional antenna. Each of the plurality of reactance load includes: a first reactance load driven as an inductive load or a capacitive load; and a second reactance load driven as an inductive load or a capacitive load. In a state in which all of the plurality of switching elements are turned on, when a switching control voltage is a ground voltage level, the inductive load is connected to a first passive antenna and the capacitive load is connected to a second passive antenna so that the second passive antenna operates as a reflector to form a unidirectional beam in a direction of −X. In a state in which all of the plurality of switching elements are turned on, when a switching control voltage is a source voltage level, the capacitive load is connected to a first passive antenna and the inductive load is connected to a second passive antenna so that the second passive antenna forms a unidirectional beam in a direction of +X. The antenna apparatus is a beam space multiple-input multiple-output (MIMO) antenna. The plurality of reactance load is provided with at least one matching stage, and the reactance value is set through the at least one matching stage. At least one of the plurality of switching elements is connected to at least one antenna of the plurality of passive antennas, and the at least one matching stage is connected to the connected switching element. The at least one matching stage is connected to between at least one antenna of the plurality of passive antennas and at least one switching element of the plurality of switching elements. After being connected to between at least one antenna of the plurality of passive antennas and at least one switching element of the plurality of switching elements, at least one matching stage is additionally connected to a rear end of the at least one switching element of the plurality of switching elements.

In accordance with another aspect of the present disclosure, a method of controlling a reactance load of an antenna apparatus including an active antenna to receive a signal, a passive antenna, a reactance load to control a driving of the passive antenna, and a switching element to control a driving of the reactance load includes: searching a target reactance load value which is able to maintain a constant impedance matching; measuring an impedance of the switching element and a transmission line by a passive antenna port; matching the measured impedance value to the searched target reactance load value; and using the measured impedance value as one of target reactance load value, when the measured impedance value and the target reactance load value satisfy a matching condition. If the measured impedance value and the target reactance load value do not satisfy the matching condition, the method further includes accomplishing a matching by adding a reactance load to the transmission line so as to reach the target reactance load value. The measured impedance value or the target reactance load value are represented by an inductance value and a capacitance value. Using the measured impedance value as one of target reactance load value includes using the measured impedance value as an inductance value or a capacitance value of a reactance load value to be implemented, when the measured impedance value is identical with one of an inductance value or a capacitance value of the target reactance load value. After using the measured impedance value as an inductance value or a capacitance value of a reactance load value to be implemented, the method further includes performing an additional matching so as to decide a remaining reactance load value. Performing an additional matching includes adding a reactance load to the transmission line so that the measured impedance value reaches the target reactance load value.

### BRIEF DESCRIPTION OF THE DRAWINGS

The objects, features and advantages of the present disclosure will be more apparent from the following detailed description in conjunction with the accompanying drawings, in which:

FIG. 1A is a perspective view of a top surface of an antenna apparatus according to an embodiment of the present disclosure;

FIG. 1B is a perspective view of a bottom surface of an antenna apparatus according to an embodiment of the present disclosure;

FIG. 2 is a flowchart illustrating a method of implementing a reactance load based on an impedance of a switch and a transmission line according to an embodiment of the present disclosure;

FIG. 3 is a graph illustrating a reactance load search result according to an embodiment of the present disclosure;

FIG. 4A is an exemplary diagram illustrating the implementation of an impedance value of a target reactance load;

FIG. 4B is an exemplary diagram illustrating a value obtained by measuring an impedance of a transmission line and the inside of a switch without connecting a reactance load;

FIG. 4C is an exemplary diagram of using the measured impedance value as one of target reactance load values;

FIG. 4D is an exemplary diagram of adding a reactance load so that the measured impedance value is matched to a target impedance value;

FIG. 5 is an exemplary diagram of adding a plurality of reactance loads;

FIG. 6 is a diagram illustrating a result of measuring the matched load value by using network analysis equipment according to an embodiment of the present disclosure;

FIG. 7A is a diagram illustrating a reflection coefficient characteristic of a beam space MIMO antenna according to an embodiment of the present disclosure;

FIG. 7B is a diagram illustrating a radiation pattern characteristic of a beam space MIMO antenna according to an embodiment of the present disclosure;

FIG. 8 is a diagram illustrating a 2×2 BPSK beam space MIMO transmission apparatus platform for checking whether a beam space MIMO antenna according to an embodiment of the present disclosure is able to accomplish a MIMO performance;

FIG. 9 is a diagram illustrating a 2×2 BPSK beam space MIMO reception apparatus platform for checking whether a beam space MIMO antenna according to an embodiment of the present disclosure is able to accomplish a MIMO performance; and

FIG. 10 is a diagram illustrating a configuration of a system to which a method for controlling a reactance load by performing an impedance matching can be applied according to an embodiment of the present disclosure.

### DETAILED DESCRIPTION OF EXEMPLARY EMBODIMENTS

Exemplary embodiments of the present disclosure are described with reference to the accompanying drawings in detail. The same reference numbers are used throughout the drawings to refer to the same or like parts. Detailed descriptions of well-known functions and structures incorporated herein may be omitted to avoid obscuring the subject matter of the present disclosure.

The present disclosure may adjust a reactance load value connected to a passive element (parasitic element) of a beam space multiple-input multiple-output (MIMO) antenna by using an absorptive switch, and implement a desired reactance load value in consideration of all of a parasitic component of an interior of the absorbent switch, a parasitic component of a transmission line, and an effect of an operation frequency.

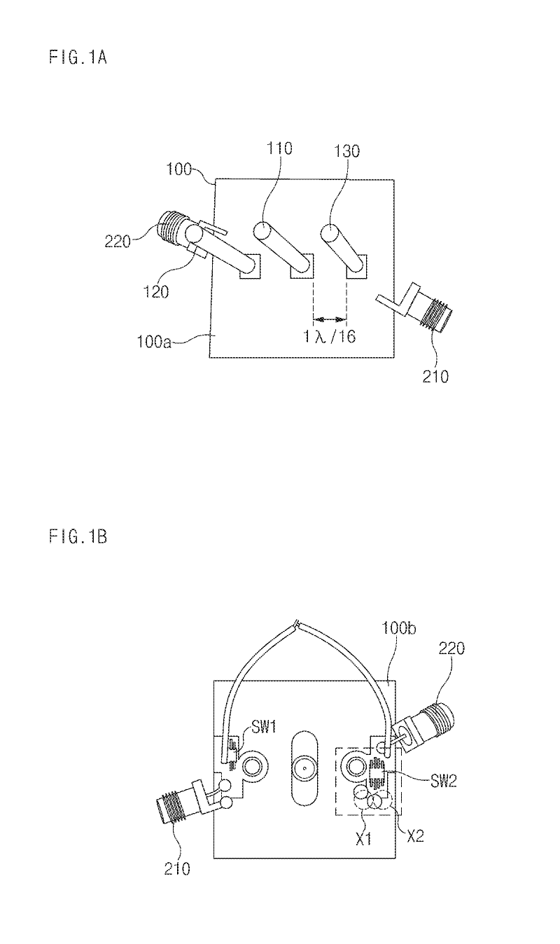

Hereinafter, embodiments of the present disclosure are described in detail with reference to FIG. 1A to FIG. 10.

FIG. 1A is a perspective view of a top surface 100a of an antenna apparatus according to an embodiment of the present disclosure, and FIG. 1B is a perspective view of a bottom surface 100b of an antenna apparatus according to an embodiment of the present disclosure.

For convenience of explanation, FIG. 1A and FIG. 1B disclose a configuration example of three monopole antennas for transmitting a binary shift phase keying (BPSK) signal, but the present disclosure may be applied to a beam space MIMO antenna having a different structure such as patch, dipole, and the like.

Referring to FIG. 1A and FIG. 1B, the antenna apparatus according to an embodiment of the present disclosure may include an active antenna 110, a plurality passive antennas 120, 130 provided in the vicinity of the active antenna 110, a reactance load X1, X2 respectively connected to the passive antenna 120, 130, and a switch SW1, SW2. At this time, the switch SW1 may be connected to the passive antenna 120 and the reactance load X1, X2 may be connected to the switch. The other switch SW2 may be connected to the passive antenna 130 and the reactance load X1, X2 may be connected to the switch SW2. In this case, each switch SW1, SW2 may be applied with a switch control voltage or may be provided with a port 210, 220 for impedance measurement.

The active antenna 110 may be an active antenna and used as a channel to which an RF signal is applied. This active antenna 110 may be surrounded by a passive antenna 120, 130 disposed at regular intervals. At this time, the number of the passive antenna is increased as the number of PSK is increased. At this time, in the case of the beam space MIMO antenna, the distance between the active antenna 110 and the passive antenna 120, 130 is important. In a typical MIMO antenna, it is required to secure a sufficient distance between antennas in order to secure isolation between antennas, but, in the case of the beam space MIMO antenna, the distance of λ/4 or less must be maintained to accomplish a spatial multiplexing. FIG. 1A illustrates an example of using the distance of λ/16.

Looking at the back of the antenna of FIG. 1B, in the case of the active antenna 110, a 50Ω SMA port may be connected to apply an uplink frequency-converted signal, and the passive antenna 120, 130 may be grounded through the switch SW1, SW2.

Hereinafter, the operation of the antenna apparatus is described. First, if both of the switches SW1 and SW2 are turned off, since the antenna apparatus may ignore the radiation pattern and the reactance, it may serve as a general monopole antenna to radiate an omnidirectional pattern.

When the beam space MIMO antenna operates, if the switches SW1 and SW2 are applied with a source voltage (V_{DC}) and turned on, the reactance load X1, X2 may be selected according to a switch control voltage Vctrl.

The value of the reactance load connected to the passive antenna 120 may be complementarily connected to the reactance load X1 or X2 according to the switch control voltage Vctrl. If the switch control voltage Vctrl is connected to 0V, the passive antenna 120, 130 may be respectively connected to the reactance load X1 (inductive load) and the reactance load X2 (capacitive load) which are connected to each switch SW1, SW2.

Thus, the passive antenna 130 connected to the capacitive load may operate as a reflector which leads a phase through an excited current to form a unidirectional beam in the direction of −X. When the switch control voltage is connected to VDD, the passive antenna 120 may be connected to the capacitive load and the passive antenna 130 may be connected to the inductive load to form a unidirectional beam in the direction of +X.

The switch SW1, SW2 may be implemented by an absorptive RF switch having a characteristic of a high isolation, a low loss, and a low parasitic component. The absorptive switch can minimize a signal reflection from the passive antenna 120, 130 to the active antenna 110, as each port shows an improved VSWR characteristic regardless of on-off modes of the switch.

In the present disclosure, a switch and a discrete component are used in order to select the reactance load value connected with each passive antenna 120, 130. That is, the present disclosure suggests a method for implementing a reactance load value by using a switch having a low driving voltage.

However, when implementing the reactance load of the passive antenna 120, 130 by connecting the switch to the discrete component, the parasitic component of the interior of the switch, the parasitic components of the transmission line for connecting a device and the switch, and the operation frequency should be considered. That is, in order to implement the load value connected with the passive antenna through the switch, a desired load value can be obtained only when all of the influence of the parasitic component of the interior of the switch, the parasitic components of the transmission line, and the operation frequency are considered to be designed.

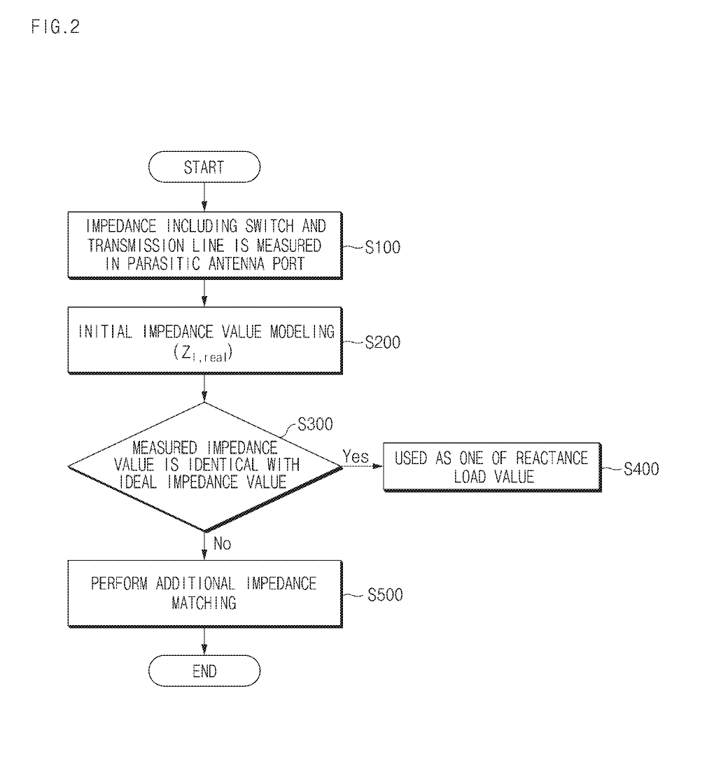

Hereinafter, the method of implementing a reactance load based on an impedance of a switch and a transmission line according to an embodiment of the present disclosure is described with reference to FIG. 2.

First, in order to implement a reactance load, the reactance load may be searched to obtain an ideal target reactance load value.

Here, the ideal target reactance load value may mean a reactance value in the state of not considering the impedance of the switch and the transmission line.

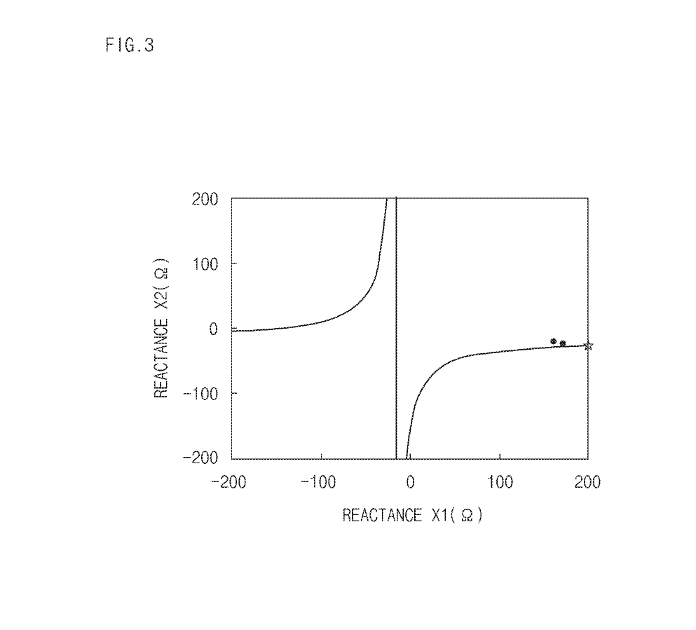

FIG. 3 illustrates a reactance load search result. The values of FIG. 3 may indicate a load value to be shown in each port and may mean a value by which the beam space antenna MIMO can maintain a constant impedance matching. That is, the value that can maintain a constant impedance matching means a point in which a return loss is minimized. In this case, the reactance load search result as in FIG. 3 may be obtained by using a conventional method.

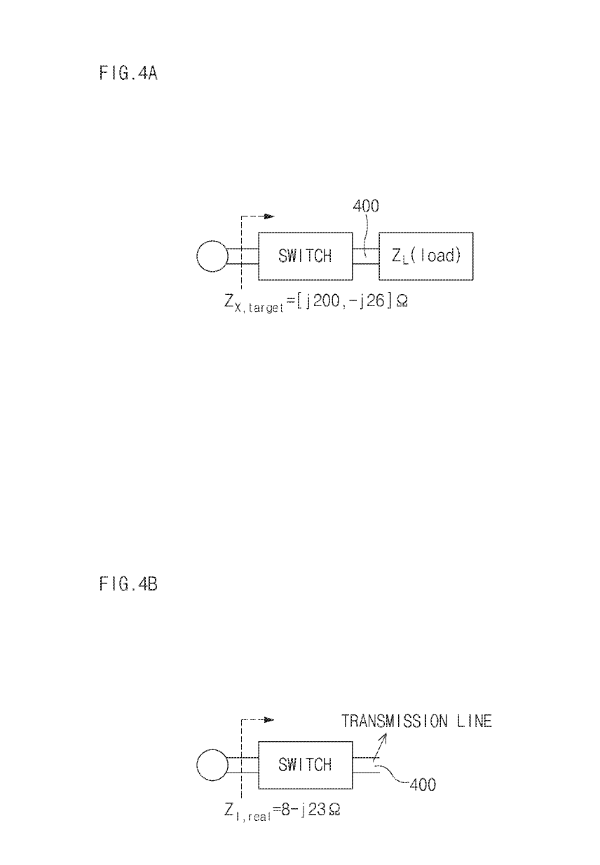

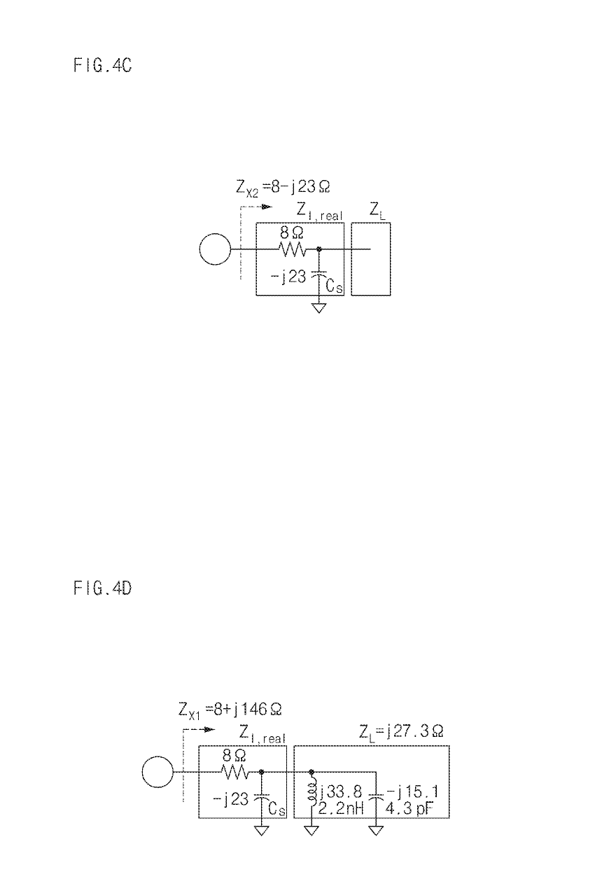

The present invention may select a point on a graph of FIG. 3 as the ideal target reactance load value, and may select, for ease of implementation, the most flat point on the graph as the target reactance load value. As shown in FIG. 4A, it is assumed that the ideal target reactance load value obtained through FIG. 3 is Z_{x,target}=[j200, −j26]Ω. This ideal target reactance load value may be changed according to the structure and the shape of the antenna, but, in general, may have a reactance value that is represented by an inductance value or a capacitance value. In addition, these reactance load values may have a plurality of values as the number of PSK is increased.

Hereinafter, the process for implementing the target reactance load value for the actual implementation is illustrated. Since a certain transmission line is needed in order to mount the switch and the discrete component (a reactance load) on an antenna substrate, the modeling of those internal components is required.

Referring to FIG. 2, in order to consider the effect of those internal components as a whole, firstly, the impedance may be measured through a network analysis apparatus (S100). As shown in FIG. 4B, if the measured impedance value is Z_{I,real}=8−j23Ω, it is modeled as an initial impedance value (S200).

Then, after comparing the impedance value Z_{I,real}=8−j23Ω measured in step S200 with the ideal target reactance load value (impedance value) Z_{x,target}=[j200, −j26]Ω, it is determined whether to perform an additional matching (S300).

In the example illustrated in FIG. 4A and FIG. 4B, since the internal impedance 8−j23 of the switch and the transmission line 400 is similar to ideal target reactance load value −j26, as shown in FIG. 4C, 8−j23Ω may be used as one of the target reactance load value (S400). At this time, when comparing the internal impedance of the switch and the transmission line with the ideal target reactance load value, if the comparison value is within a certain error range, it can be considered as a matching.

However, if the value of the measured impedance is much different from the ideal target reactance load value, an additional impedance matching may be required (S500). Thus, in order to accomplish the additional impedance matching, the number of matching stages should be determined firstly.

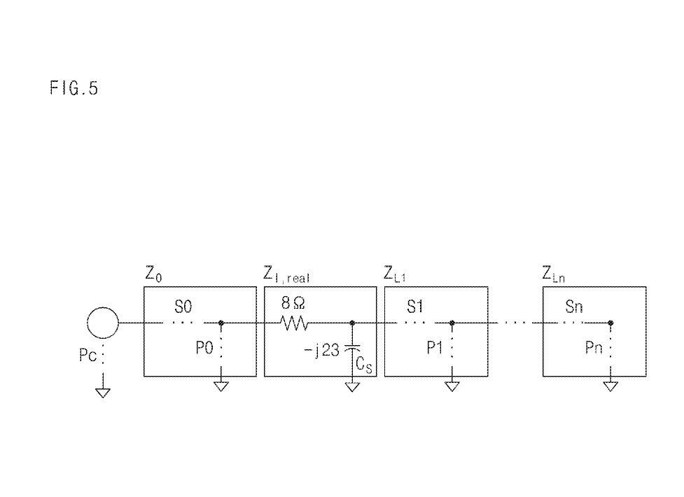

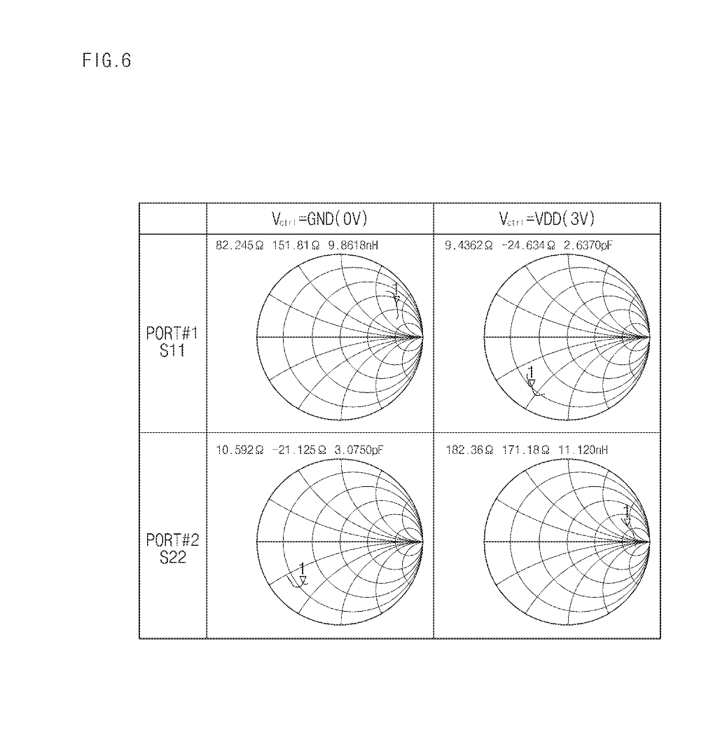

As shown in FIG. 5, in some cases, only one matching stage (Z_{L1}) may be required, but multi-stage matching stages (Z_{L2}, Z_{L3} . . . Z_{Ln}) may be required in order to perform a more accurate matching. Each matching stage may select a certain load value (capacitor or inductor) in series or in parallel to implement a desired load value. Since the matching stage Z_{L} is positioned in the rear end of the switching element and the transmission line, the influence may be attenuated by Z_{I,real} of the front stage. Thus, if it is difficult to implement the target impedance by only the ZL matching stage, the matching stage may be positioned in the front of the switching element and the transmission line to implement the target reactance load value for implementation. For a similar purpose, the matching may be performed through the discrete component connected in parallel to the parasitic antenna port. Meanwhile, when performing this matching, in general, it is preferable to use the discrete component to achieve an easy implementation, but the discrete component may be replaced with the transmission line in order to reduce an error.

Meanwhile, in the example of the present disclosure, as shown in FIG. 4C, when there is no load, one of the target load value can be satisfied, and thus the satisfied value is used, and another load value may be implemented through the Z_{L1} matching stage.

Since the target load value is an inductance value j200, a value j26Ω which is connected in parallel to −j23Ω is needed. However, since it is not possible to correctly implement such a load value through the discrete component, the matching is performed through the most similar value to j26Ω by combining various component values.

Referring to FIG. 4D, in the example of the present disclosure, j27.3Ω is implemented through a parallel connection of 2.2 nH and 4.3 pF. The value of the impedance load implemented through the above value is j146Ω, and this value is different from the ideal target reactance load value. However, since this value is matched to a point on the reactance load search graph of FIG. 3, the use of this value does not deteriorate the performance of the beam space MIMO antenna. Hence, it is preferable to use this value without additional matching.

The implementation of the reactance load through such a method has an advantage that the reactance load can be implemented regardless of the load value. That is, in order to implement the reactance load using a conventional diode, a capacitance value that linearly increases depending on the control value of the voltage may be implemented. However, in order to implement an inductance value through this, those values require an additional transformable circuit to increase the complexity. However, by using the implementation method of the present disclosure, the load value can be easily implemented regardless of whether the reactance load is a capacitor component or an inductance component.

FIG. 6 is a diagram illustrating a result of measuring the matched load value by using network analysis equipment according to an embodiment of the present disclosure.

FIG. 6 illustrates a load value when the control voltage of the switch in each passive antenna port is 0V and a VDD voltage. Looking at the measured value, it can be seen that it is well matched with the above described theoretical result. Meanwhile, in the reactance load search result, the ideal target load value should have only a reactance component. However, it can be seen that the matched load value shows the impedance value containing the real number term due to the internal resistance of the switch and the resistance component of the transmission line. Since this real number term becomes a cause of reducing the performance of the antenna, it is desirable to minimize it.

In the present disclosure, the switches SW1 and SW2 are used as the absorptive switch, and the reason for this is described in detail below.

The implementation of the reactance load value through the switch is very simple and easy to implement a load value in comparison with the conventional methods, but not all types of switch can be used. An analog switch, a reflective RF switch, and an absorptive RF switch are compared and described, as three types of switches that are commonly widely used.

First, although a typical analog switch has an advantage such as a good on-off characteristic, a low on resistance characteristic, a large control voltage range, and the like, as the internal parasitic capacitance is very large and the isolation characteristic of the carrier frequency is poor, it is not appropriate to use in the present disclosure.

Meanwhile, the reflective RF switch has a high isolation characteristic and a small parasitic capacitance. That is, when matching the reactance loads X1 and X2, since one port should not affect the other port, the isolation between two ports should be always kept high. When the switch is turned off, the reflective RF switch configured through a termination resistor of 0Ω has a high isolation characteristic and a small parasitic capacitance compared to an analog switch, but the switch is available only when a high voltage standing wave ratio (VSWR) of the off-port does not matter.

On the other hand, when the switch is turned off, since the absorptive switch connected with a termination parallel resistor of 50Ω shows an improved VSWR characteristic in each port regardless of the switch mode, the reflection signal from a passive antenna to an active antenna can be minimized.

Thus, the present disclosure may utilize the absorptive RF switch having characteristics of high isolation, low loss, and low parasitic component to configure the load of the beam space MIMO antenna through a switch.

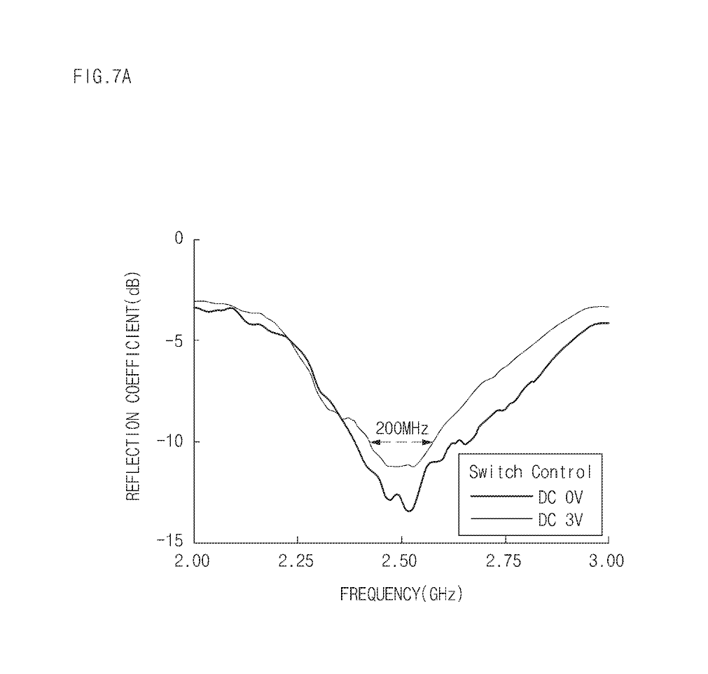

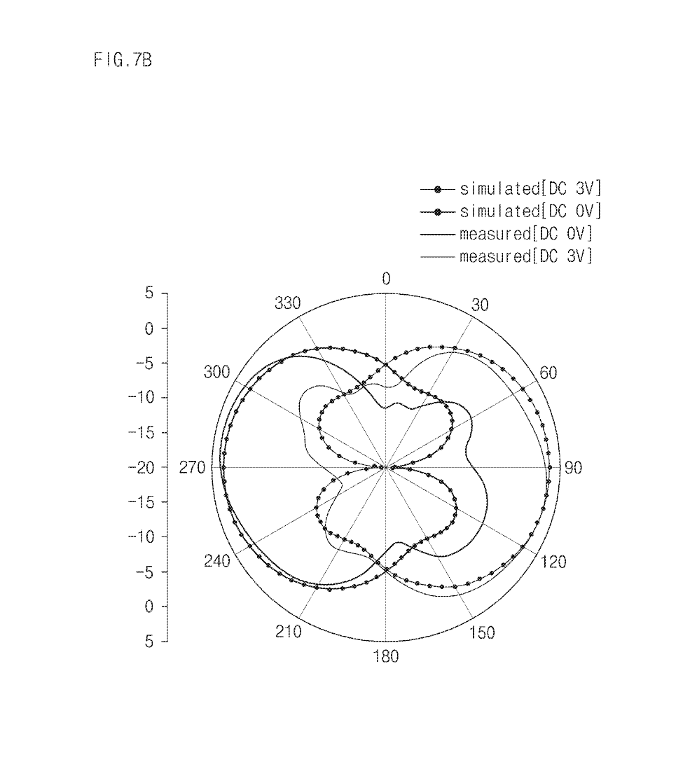

FIG. 7A is a diagram illustrating a reflection coefficient characteristic of a beam space MIMO antenna according to an embodiment of the present disclosure, and FIG. 7B is a diagram illustrating a radiation pattern characteristic of a beam space MIMO antenna according to an embodiment of the present disclosure.

Referring to FIG. 7A, since the reflection coefficient is −10 dB or more at 2.45 GHz, it can be seen that the manufactured antenna shows an excellent matching characteristic at a given carrier frequency.

Referring to FIG. 7B, in terms of a specific radiation pattern in the inside of an anechoic chamber, it can be seen that the radiation pattern is well steered from side to side according to the control voltage of the switch.

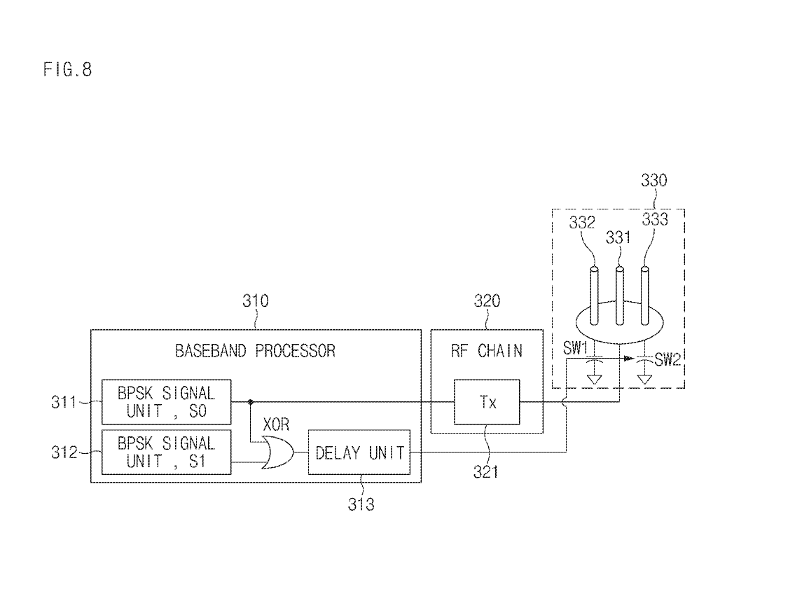

FIG. 8 is a diagram illustrating a 2×2 BPSK beam space MIMO transmission apparatus platform for checking whether a beam space MIMO antenna according to an embodiment of the present disclosure is able to accomplish a MIMO performance.

The BPSK beam space MIMO transmission apparatus may be provided with a baseband processor 310, a RF chain 320, and an antenna apparatus 330.

The baseband processor 310 may be provided with a BPSK signal unit 311, 312, an exclusive OR (XOR), and a delay unit 313.

The BPSK signal unit 311, 312 may output a BPSK signal S0, S1.

The exclusive OR (XOR) may perform an exclusive OR operation for the BPSK signal S0, S1, and the delay unit 313 may delay an output signal of the exclusive-OR gate XOR to transmit to the switch SW1, SW2 of the antenna apparatus 330 so that the reactance load value of the passive antenna may be adjusted.

The RF chain 320 may be implemented of a single configuration, and the antenna apparatus 330 may be configured of an active antenna 331 and a passive antenna 332, 333.

Since the present disclosure controls the reactance load by using the switch, the baseband digital processor 310 may be connected directly to the switch SW1, SW2. On the other hand, since the conventional method needs a high driving voltage, it requires an additional voltage driving circuit. In the present disclosure, it is possible to adjust the synchronization between the two signals more easily by eliminating such a voltage driving circuit.

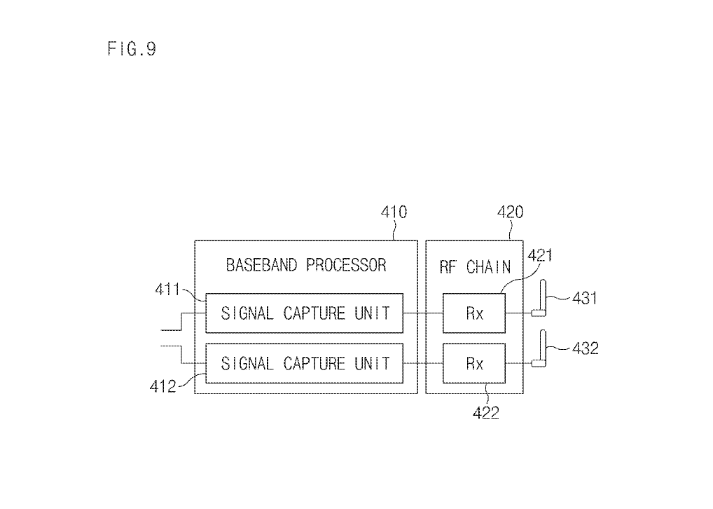

FIG. 9 is a diagram illustrating a 2×2 BPSK beam space MIMO reception apparatus platform for checking whether a beam space MIMO antenna according to an embodiment of the present disclosure is able to accomplish a MIMO performance.

The reception apparatus may be designed to verify the performance of the beam space MIMO antenna and implemented by using a two general monopole antenna.

A signal received by the reception apparatus may be separated into S0 and S1 signals through a general restoring method, and a signal transmitted through a single RF chain may be completely separated by the reception apparatus side.

Thus, the present invention is able to control the reactance load of the beam space MIMO antenna very simply through the switch and obtain low power consumption and high dynamic performance.

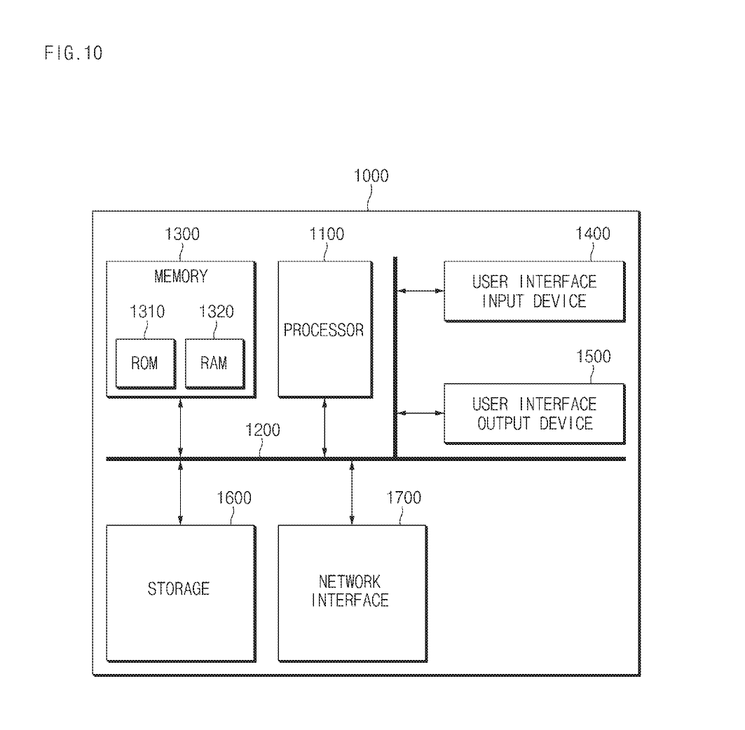

FIG. 10 is a diagram illustrating a configuration of a system to which a method for controlling a reactance load by performing an impedance matching can be applied according to an embodiment of the present disclosure.

Referring to FIG. 10, the computing system 1000 may include at least one processor 1100 which is connected via a bus 1200, memory 1300, an user interface input device 1400, an user interface output device 1500, a storage 1600, and a network interface 1700. The processor 1100 may be a semiconductor device for performing a processing for instructions stored in a central processing unit (CPU) or the memory 1300 and/or the storage 1600. The memory 1300 and the storage 1600 may include various types of volatile and nonvolatile storage media. For example, the memory 1300 may include a Read Only Memory (ROM) 1310 and Random Access Memory (RAM) 1320.

Thus, the steps of the method or the algorithm described in association with the embodiments disclosed herein may be directly implemented by a hardware, a software module, or a combination of the two executed by the processor 1100. The software module may reside in a storage medium (i.e., in the memory 1300 and/or the storage 1600) such as a RAM memory, a flash memory, a ROM memory, an EPROM memory, an EEPROM memory, a register, a hard disk, a removable disk, and CD-ROM. The exemplary storage medium may be coupled to the processor 1100, and the processor 1100 may read information from the storage medium and write information to the storage medium. Alternatively, the storage medium may be integrated in the processor 1100. The processor and the storage medium may reside in an application specific integrated circuit (ASIC). The ASIC may reside in a user terminal. Alternatively, the processor and the storage medium may reside in the user terminal as an individual component.

This technology does not need to be provided with an additional voltage driving circuit so that a baseband digital processor may directly drive an antenna control switch to minimize an effect of mismatch between multiple signals.

In addition, this technology can minimize the number of discrete component which is additionally provided in order to obtain a target reactance value, and does not need to be provided with a separate calibration kit for adjusting a reactance value.

In addition, this technology uses an absorptive switch so that the power consumption is low and it is possible to minimize an area consumption of the antenna apparatus.

In addition, this technology can easily implement all reactance values regardless of whether the reactance load to be implemented is an inductance component or a capacitance component.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An antenna apparatus comprising:
an active antenna configured to transmit and receive a signal;
a plurality of passive antennas which are provided in a periphery of the active antenna and which determine a beam pattern;
a plurality of reactance loads configured to control a driving of the plurality of passive antennas respectively; and
a plurality of switching elements configured to control a driving of the plurality of reactance loads,
wherein a reactance value of the plurality of reactance loads is determined according to an impedance of the plurality of switching elements and a transmission line.

2. The antenna apparatus of claim 1, wherein the plurality of switching elements are an absorptive switch.

3. The antenna apparatus of claim 1, wherein, when the plurality of switching elements are turned off, the antenna apparatus is driven as an omnidirectional antenna.

4. The antenna apparatus of claim 1, wherein each of the plurality of reactance load comprises:
a first reactance load driven as an inductive load or a capacitive load; and
a second reactance load driven as an inductive load or a capacitive load.

5. The antenna apparatus of claim 4, wherein, in a state in which all of the plurality of switching elements are turned on, when a switching control voltage is a ground voltage level, the inductive load is connected to a first passive antenna and the capacitive load is connected to a second passive antenna so that the second passive antenna operates as a reflector to form a unidirectional beam in a direction of −X.

6. The antenna apparatus of claim 4, wherein, in a state in which all of the plurality of switching elements are turned on, when a switching control voltage is a source voltage level, the capacitive load is connected to a first passive antenna and the inductive load is connected to a second passive antenna so that the second passive antenna forms a unidirectional beam in a direction of +X.

7. The antenna apparatus of claim 1, wherein the antenna apparatus is a beam space multiple-input multiple-output (MIMO) antenna.

8. The antenna apparatus of claim 1, wherein the plurality of reactance load is provided with at least one matching stage, and the reactance value is set through the at least one matching stage.

9. The antenna apparatus of claim 8, wherein at least one of the plurality of switching elements is connected to at least one antenna of the plurality of passive antennas, and the at least one matching stage is connected to the connected switching element.

10. The antenna apparatus of claim 8, wherein the at least one matching stage is connected to between at least one antenna of the plurality of passive antennas and at least one switching element of the plurality of switching elements.

11. The antenna apparatus of claim 10, after being connected to between at least one antenna of the plurality of passive antennas and at least one switching element of the plurality of switching elements, wherein at least one matching stage is additionally connected to a rear end of the at least one switching element of the plurality of switching elements.

12. A method of controlling a reactance load of an antenna apparatus including an active antenna to receive a signal, a passive antenna, a reactance load to control a driving of the passive antenna, and a switching element to control a driving of the reactance load, the method comprising:
searching a target reactance load value which is able to maintain a constant impedance matching;
measuring an impedance of the switching element and a transmission line by a passive antenna port;
matching the measured impedance value to the searched target reactance load value; and
using the measured impedance value as one of target reactance load value, when the measured impedance value and the target reactance load value satisfy a matching condition.

13. The method of claim 12, if the measured impedance value and the target reactance load value do not satisfy the matching condition, further comprising accomplishing a matching by adding a reactance load to the transmission line so as to reach the target reactance load value.

14. The method of claim 12, wherein the measured impedance value or the target reactance load value are represented by an inductance value and a capacitance value.

15. The method of claim 14, wherein using the measured impedance value as one of target reactance load value comprises using the measured impedance value as an inductance value or a capacitance value of a reactance load value to be implemented, when the measured impedance value is identical with one of an inductance value or a capacitance value of the target reactance load value.

16. The method of claim 15, after using the measured impedance value as an inductance value or a capacitance value of a reactance load value to be implemented, further comprising performing an additional matching so as to decide a remaining reactance load value.

17. The method of claim 16, wherein performing an additional matching comprises adding a reactance load to the transmission line so that the measured impedance value reaches the target reactance load value.
